(19) United States
(12) Patent Application Publication
(10) Pub. No.: US 2012/0143630 A1
(43) Pub. Date: Jun. 7, 2012

(54) THIRD PARTY VERIFICATION OF INSURABLE INCIDENT CLAIM SUBMISSION

(75) Inventor: DAVID HERTENSTEIN, COPPELL, TX (US)

(73) Assignee: INTERNATIONAL BUSINESS MACHINES CORPORATION, ARMONK, NY (US)

(21) Appl. No.: 12/961,699

(22) Filed: Dec. 7, 2010

(51) Int. Cl. G06Q 40/00

(52) U.S. Cl. 705/4

(57) ABSTRACT

Incident data for an insurance claim associated with an incident can be received by an incident application executing within a computing device. The incident can be an insurable event associated with an insurance policy of an insurance carrier. The incident data can be simultaneously conveyed to an independent third party entity as a serialized data format and as an insurance claim to the insurance carrier. The third party entity can automatically verify the incident data and generate a verification report. The verification report can be associated with the incident claim. The verification report can be communicated to the insurance carrier which can be utilized to determine the validity of the insurance claim.

### BACKGROUND

The present invention relates to the field of third party verification and, more particularly, to third party verification of insurable incident claim submission.

Currently, when a traffic accident occurs, there are many actions which can be performed to resolve the situation. One common action is filing an insurance claim about the accident to an appropriate insurance carrier. An insurance claim typically includes information such as a description of the accident and information of involved drivers. For example, accident reports usually include a written description of an accident indicating relevant details of the accident.

In many instances, a driver involved in an accident must manually collect information regarding the accident. Occasionally, insurance carriers provide a checklist of information which can be collected to assist in a claim submission. However, many times, drivers do not collect all relevant information due to many reasons which can result from oversight (e.g., responding to a stressful situation) to inexperience. For example, frequently drivers involved in accidents are inundated with responsibilities such as seeking medical attention for other involved parties. Frequently, missing information can often add significant delays in processing insurance claims. These delays can negatively impact policyholders and other involved parties.

In worse case scenarios, false information can be provided by drivers involved in an accident. In some cases, false information is provided to hide driver information and in other cases to defraud an insurance carrier.

### SUMMARY

Incident data for an insurance claim associated with an incident can be received by an incident application executing within a computing device. The incident can be an insurable event associated with an insurance policy of an insurance carrier. The incident data can be simultaneously conveyed to an independent third party entity as a serialized data format and as an insurance claim to the insurance carrier. The third party entity can automatically verify the incident data and generate a verification report. The verification report can be associated with the insurance claim. The verification report can be communicated to the insurance carrier which can be utilized to determine the validity of the insurance claim.

### BRIEF DESCRIPTION OF THE SEVERAL VIEWS OF THE DRAWINGS

FIG. 1 is a flowchart illustrating a method for third party verification of insurable incident claim submission in accordance with an embodiment of the inventive arrangements disclosed herein.

FIG. 2 is a schematic diagram illustrating a system for third party verification of insurable incident claim submission in accordance with an embodiment of the inventive arrangements disclosed herein.

FIG. 3 is a schematic diagram illustrating an exemplary report for third party verification of insurable incident claim submission in accordance with an embodiment of the inventive arrangements disclosed herein.

### DETAILED DESCRIPTION

The present disclosure is a solution for third party verification of insurable incident claim submission. In the solution, incident data associated with an incident (e.g., traffic collision) can be collected utilizing one or more mobile devices. The mobile devices can marshal incident data into a standardized format which can be communicated to a third party organization. In one embodiment, an incident claim submission including incident data can be simultaneously conveyed to an independent third party organization and an insurance carrier. The third party organization can confirm receipt of incident data from relevant entities (e.g., drivers) and perform verification actions on incident data. Verification can include, but is not limited to, address verification, personally identifiable information verification, vehicle registration verification, and the like. The third party organization can authenticate incident data which can be conveyed to an appropriate insurance carrier for claim processing.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction processing system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

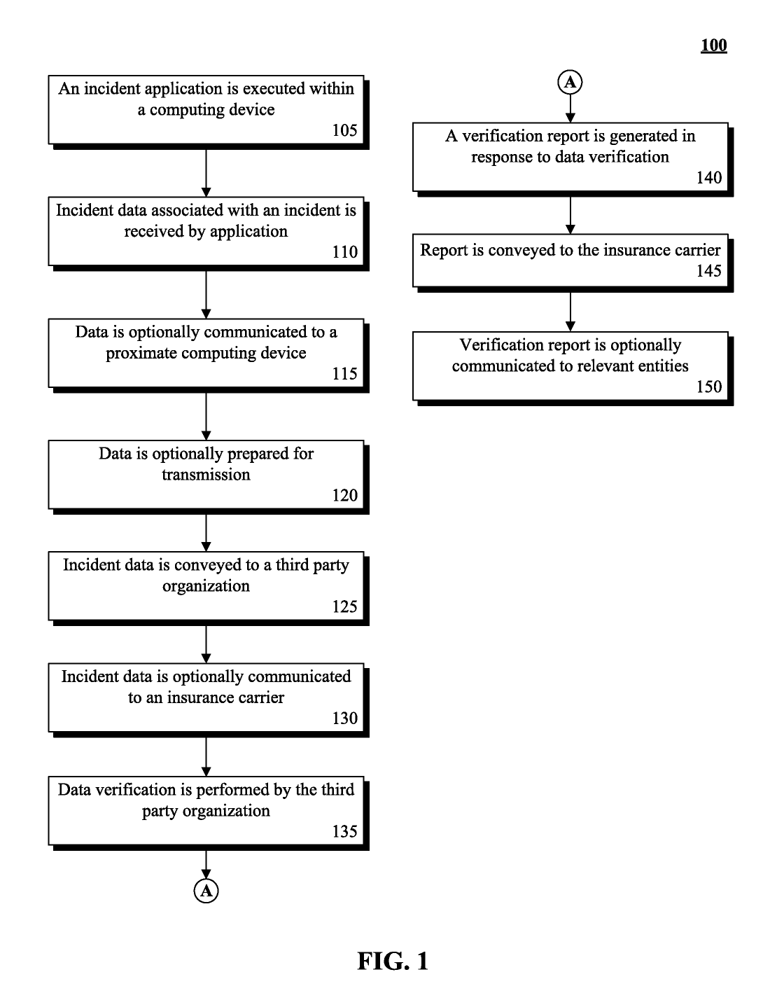

FIG. 1 is a flowchart illustrating a method 100 for third party verification of insurable incident claim submission in accordance with an embodiment of the inventive arrangements disclosed herein. Method 100 can be a component of a business process able to identify, receive, validate, and process an insurance claim associated with an insurable incident (e.g., traffic collision). The method 100 can be associated with computing elements including, but not limited to, mobile computing devices (e.g., mobile phone), server computing components, network elements, and the like.

In one instance, method 100 can be associated with a mobile phone application able to collect incident data. In the instance, the collected incident data can be simultaneously submitted to an appropriate incident server associated with an insurance carrier and a verification server associated with a third party verification organization. For example, a driver involved in a car accident can utilize a mobile phone application to submit an insurance claim while at the scene of the accident, which can be automatically verified by a third party organization.

In another instance, the collected incident data can be conveyed initially to a third party organization for verification. In the instance, upon verification of the incident data, an insurance claim can be generated with valid incident data and can be communicated to an insurance carrier.

In step 105, an incident application is run within a computing device. In one instance, the incident application can be a mobile computing device application (e.g., mobile application). In another instance, incident application can be a desktop computing application executing on a computing device (e.g., desktop computer). In step 110, incident data associated with an insurable incident can be received by the application. Incident data can include, but is not limited to, driver information, vehicle registration information, location data, multimedia data (e.g., photographs), and the like. Application can receive incident data through one or more user input sources including, but not limited to keyboard, mouse, omni-directional trackball, keypad, camera, microphone, and the like.

As used herein, incident data can be linked to an insurance claim associated with an insurance carrier. Insurance claim can be a digital artifact associated with incident data identifying an insurable incident. An insurable incident can be an event occurrence associated with an insurance policy provided by an insurance carrier. Insurance carrier can be an entity able to indemnify a policyholder associated with the insurance claim. A policyholder can be a participant affected by the insurable incident (e.g., driver of a vehicle). Policyholder can include, but is not limited to, a person, an organization, and the like.

In step 115, incident data can be optionally communicated to a proximate computing device. In one embodiment, the incident application can communicate with proximate computing devices (e.g., other mobile phones) to obtain incident data. Computing devices can exchange incident data utilizing one or more wired and/or wireless technologies, including, but not limited to Universal Serial Bus (USB), WiFi, Infrared, BLUETOOTH, and the like. For instance, drivers can utilize incident applications executing on each driver's mobile phone to exchange information (e.g., via bluetooth) about an accident. In one configuration of the embodiment, incident data can be digitally signed and secured enabling non-public information to be maintained. In the embodiment, digital security can include digital signatures, digital certificates, and the like. In one embodiment, incident data can be digitally encoded into a two dimensional barcode, a Quick Response (QR) code, a PDF417 barcode, and the like. That is, incident data can be encoded into any traditional and/or proprietary format enabling information sharing while maintaining security.

In step 120, incident data can be optionally prepared for transmission. In one instance, incident data can be marshaled into a traditional and/or proprietary format. Formats can include, but is not limited to, Extensible Markup Language (XML), Hypertext Markup Language (HTML), Javascript Object Notation (JSON), and the like. In another instance, incident data can be associated with one or more encryption mechanisms. Encryption mechanisms can include, but is not limited to, Public Key cryptography, Private Key cryptography, and the like.

In step 125, the incident data can be conveyed to a third party organization for verification. The third party organization can be an independent entity not directly associated with an insurance carrier. For clarity, third party organization can be referred to as verification entity henceforth. Verification entity can include, but is not limited to, a third party verification service, one or more third party verification organizations, and the like. In step 130, the incident data can be optionally communicated to an insurance carrier. In one instance, the incident data can be conveyed to an insurance carrier utilizing a proprietary claim submission format. In one embodiment, step 130 can be optionally omitted and incident data can be conveyed to insurance carrier upon validation (e.g., step 140,145).

In step 135, data verification can be performed by the verification entity. Verification can include identity determination, information accuracy confirmation, and the like. It should be appreciated that verification can include automated and/or non-automated mechanisms. In one embodiment, incident data can be analyzed to determine missing information, incorrect data, false information, and the like. In one instance, incident data can be verified against policyholder information. In another instance, incident data can be verified utilizing data from external data sources. External data sources can be data sources associated with organizations including, but not limited to, law enforcement agencies, government agencies, information accuracy confirmation, medical agencies, banking services, credit services, and the like.

In one embodiment, data verification can be performed in interactively and in real-time or near real-time. In the embodiment, data communicated to the verification entity can be verified in real-time and can convey validation results to a computing device. For example, a user can receive instant feedback when an insurance claim submission lacks necessary information.

In step 140, a verification report can be generated in response to the data verification. Verification report can be a digital artifact able to establish the validity of an insurance claim and/or incident data associated with an insurance claim. Verification report can be associated with a verification code permitting linking an insurance claim to a verification report. In one embodiment, verification code can be communicated as a receipt of transmission. In the embodiment, when incident data is received by a verification entity, a verification code can be communicated to a transmitting entity.

In step 145, the verification report can be conveyed to the insurance carrier. In one instance, the verification report can be an insurance claim associated with a verification value. In the instance, the verification value can indicate the degree of validation of the insurance claim. For example, verification report can be associated with a verification value of eighty percent, indicating the insurance claim is likely valid. In another instance, verification report can be an itemized validation of incident data. In yet another instance, verification report can be associated with a binary value (e.g. Valid/Not Valid). In the instance, the verification report can indicate when an insurance claim is inaccurate.

In step 150, the verification report can be communicated to relevant entities. Relevant entities can include, but is not limited to, law enforcement agencies, medial agencies, legal agency, and the like. In one embodiment, the verification report can lack personally identifiable information. That is, verification report can be a neutral report utilized within a moderation process. In another embodiment, verification report can include personally identifiable information, vehicle registration, location data, and the like.

Drawings presented herein are for illustrative purposes only and should not be construed to limit the invention in any regard. Method 100 can be performed concurrently and iteratively for each insurance claim submission. It should be appreciated method 100 can be associated with a mobile computing device, but is not limited in this regard. Further, step 135 of method 100 can be automated or manually enacted. For example, data verification can include executing an investigation.

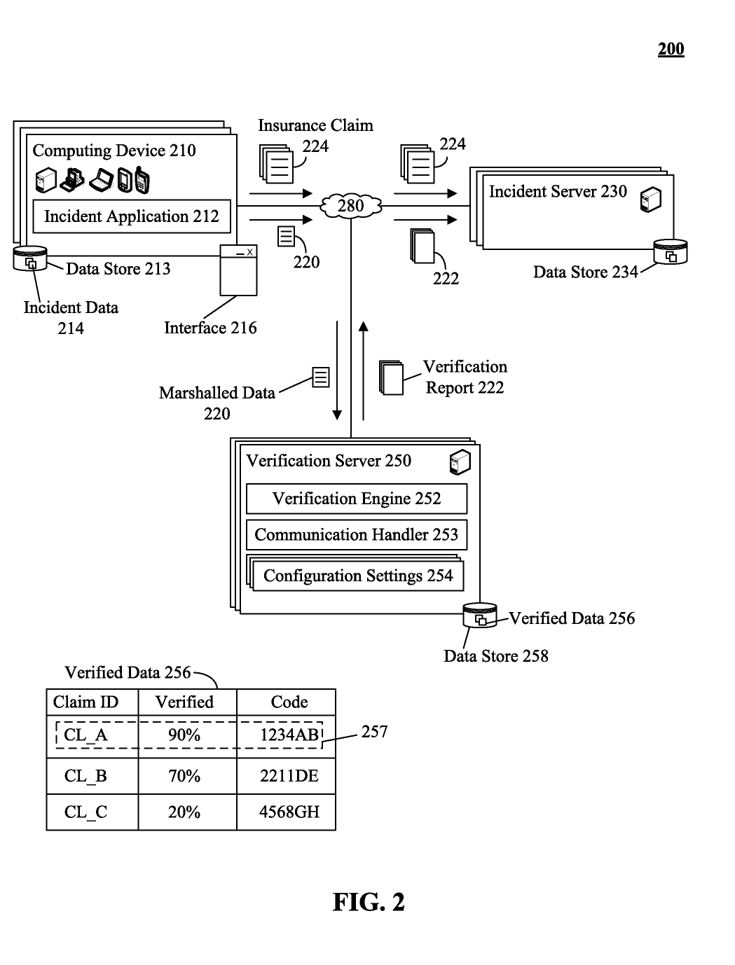

FIG. 2 is a schematic diagram illustrating a system 200 for third party verification of insurable incident claim submission in accordance with an embodiment of the inventive arrangements disclosed herein. System 200 can be present in the context of system 100. In system 200, a verification server 250 can provide a third party verification service enabling insurance claim 224 to be automatically verified. Incident data 214 collected from incident application 212 executing on computing device 210 can be utilized to generate data 220 and insurance claim 224. Data 220 and claim 224 can be conveyed via network 280 to verification server 250 and incident server 230.

As used herein, marshaled data 220 can be one or more portions of incident data 214 (e.g., geographic location) which conform to a data serialization format. Format can include, but is not limited to, human readable formats, binary formats, and the like. In one embodiment, data 220 can be a data set conforming to a traditional data format (e.g., XML). Data 220 can include, but is not limited to, arrays, hash tables, binary trees, and the like. Data 220 can include, but is not limited to, driver information, vehicle registration information, location information, and the like. In one instance, data 220 can be a proprietary format which can be converted to a traditional format by communication handler 253. In one embodiment, data 220 can be a dataset of incident data lacking an organizational structure. In one embodiment, data 220 can conform to an organization identical to an insurance claim.

In one instance, data 220 can be verified through a series of incremental steps associated with multiple verification entities (e.g. server 250). In the instance, data 220 can be communicated to successive verification entities during a verification process. Once data is validated, the verified data 256 can be stored within data store 258 reducing redundant verification processes.

In one embodiment, server 250 can be responsive to verification requests from incident server 230. In the embodiment, server 250 can provide verified data 256 based on incident data received from server 230.

Computing device 210 can be a hardware/software entity able to execute incident application 212. Device can include, but is not limited to, incident application 212, data store 213, interface 216, and the like. Device 210 can include, but is not limited to, mobile phone, laptop, portable digital assistant (PDA), portable multimedia player, tablet computing device, desktop computer, and the like. Device 210 can include components not shown, including, but not limited to, processor, volatile memory, non-volatile memory, bus, camera, microphone, and the like. It should be appreciated computing device 210 can include multiple computing devices proximate and/or remote.

Incident application 212 can be a software entity permitting collection of incident data. Application 212 can include, but is not limited to, a mobile application, desktop application, Web-based application, and the like. For example, the incident application can be a JAVA 2 ENTERPRISE EDITION (J2EE) application. In one instance, application 212 can be a Web service provided by an insurance carrier and/or a third party entity. In one embodiment, application 212 can serialize data 214 which can be communicated to server 230, 250. In one configuration of the embodiment, data 220 and claim 224 can conform to traditional data formats (e.g., Extensible Markup Language). In another configuration of the embodiment, data 220 can be a traditional data format and claim 224 can be a proprietary data format. Application 212 can be associated with interface 216.

Interface 216 can be a hardware/software entity for collecting, presenting, and/or managing incident data 214. Interface 216 can include, but is not limited to, visual and aural components. Interface 216 can be a graphical user interface, text-based interface, multi-modal interface, and the like. Interface 216 can include, but is not limited to, mobile application interface, desktop interface, Web-based interface, and the like. In one instance, interface 216 can be a Web browser able to collect and/or communicate incident data 216 to proximate computing devices, remote computing devices, and the like. In one embodiment, interface 216 can present a barcode representation of incident data 214 permitting rapid and automated sharing of incident data 214. In one instance, a transmission receipt can be presented within interface 216 when data 220 and/or insurance claim 224 is communicated to server 250, 230.

Incident server 230 can be a hardware/software entity permitting processing of insurance claim 224 and/or verification report 222. Server 230 can include, but is not limited to data store 234, historic insurance claims (not shown), and the like. In one instance, server 230 can be associated with an insurance carrier. In another instance, server 230 can be a component of a verification entity.

Verified data 256 can be one or more portions of data 220 which have been validated. Data 256 can include, but is not limited to, claim identifier, verification value, verification code, and the like. For instance, entry 257 can indicate a claim CL_A is ninety percent valid and ready for claim processing. Claim identifier (e.g., CL_A) can be utilized to identify an insurance claim 224. In one instance, claim identifier can be a uniquely generated value with server 250 scope. That is, claim identifier can be an internal identifier utilized by server 250. In another instance, claim identifier can be automatically determined from insurance claim 224. Verification value (e.g., 90%) can be an arbitrary value utilized to indicate the degree of confidence of a portion of data. In one instance, verification value can be a percentage value, character value (e.g., A, B, etc), word value, numerical point value, and the like. Verification code (e.g., 1234AB) can be a unique identifying value permitting tracking and/or auditing of an insurance claim and/or data 220 transmission. For example, verification code can be utilized to perform searches against verified data 256.

Verification server 250 can be a hardware/software entity for receiving incident data. Server 250 can include, but is not limited to, verification engine 252, communication handler 253, configuration settings 254, data store 258, and the like. Server 250 can be a network element, distributed computing element, cloud computing component, and the like. It should be appreciated that server 250 can include multiple servers communicatively linked to perform verification actions. In one instance server 250 can be an IBM WEBSPHERE middleware.

Verification engine 252 can be a software component for verifying incident data. Engine 252 can be configured to validate incident data for selection, accuracy, and the like. Engine 252 can perform partial validation, full validation, cross-validation, revalidation, and the like. For instance, engine can partially verify an insurance claim by enacting address verification. In one instance, engine 252 can be utilized to verify multiple insurance claims associated with an incident. In the instance, engine 252 can cross-check incident data from two or more insurance claims to determine data validity of each insurance claim.

Communication handler 253 can be a software component for communicating with components 210, 230. Handler 253 can be a multi-modal telecommunication entity permitting simultaneous and/or concurrent connectivity with components 210, 230. Handler 253 can be associated with one or more wired and/or wireless communication mechanisms. Wireless communication can include, but is not limited to, mobile phone networks, landline networks, and the like. Handler 253 can negotiate exchange of data 220 and/or report 222. Handler 253 can utilize one or more communication mechanisms including, but not limited to, postal mail, facsimile, Short Message Service, Electronic Mail, Multimedia Messaging Service, and the like.

Configuration settings 254 can be one or more parameters for establishing the behavior of server 250 and/or components 252, 254. Settings 254 can include, but is not limited to, verification settings, security settings, external data sources, and the like. Security settings can include, but is not limited to, access profiles/restrictions, encryption settings, and the like. In one embodiment, settings 254 can permit the compartmentalization of verified data 256 protecting user and/or organization information. In one instance, settings 254 can be established as a profile associated with an incident server 230. In the instance, customized settings for an incident server can be supported enabling flexible validation processes. For example, insurance agencies can utilize settings 254 to verify insurance claims without modifying existing corporate policies and/or processes.

Verification report 222 can be a digital document identifying valid portions of data 222. Report 222 can conform to a traditional and/or proprietary format including, but not limited to, Hypertext Markup Language (HTML), Portable Digital Format, and the like. In one instance, report 222 can be a comma separated value (CSV) formatted file. In another instance, report 222 can be a portion of a database table. Report 222 can be communicated to server 230 which can be used to verify claim 224. In one embodiment, report 222 can be an insurance claim which can be communicated to server 230 upon validation.

Data store 258 can be a hardware/software entity for persisting verified data 256. In one instance, data store 258 can be a network element of a distributed computing environment. In the instance, data store 258 can be a Storage Area Network, Network Area Storage, and the like. In one embodiment, data 256 can be temporarily stored within data store 258. In the embodiment, data 256 can be revalidated periodically to determine data validity. For example, when data 256 is determined to be invalid, server 250 can purge the invalid data.

Drawings presented herein are for illustrative purposes only and should not be construed to limit the invention in any regard. System 200 can operate with a client-server model, peer-to-peer model, and the like. In one embodiment, system 200 can be a component of a Service Oriented Architecture (SOA). In the embodiment, system 200 functionality can be encapsulated as a Software as a Service (SaaS) modality. System 200 can conform to a Representational State Transfer (REST) software architecture. Data store 258, 234 can be include, but is not limited to, a Relational Database Management System (RDBMS), an Object Oriented Database Management System (OODBMS), and the like.

It should be noted that engine 252 can perform additional validation and verification operations including, but not limited to, bounds checking, location determination, and the like. It should be appreciated that engine 252 can perform concurrent validation of multiple portions of data 220. That is, portions data set 220 can be verified in parallel enabling rapid validation to be achieved. In one embodiment, engine 252 can be capable of accuracy checking utilizing one or more internal and/or external resources. In the embodiment, engine 252 can forecast the probability an insurance claim is inaccurate.

It should be appreciated that the verification value within system 200 can be computed utilizing one or more mechanisms and/or algorithms. Mechanisms can include, but is not limited to, threshold evaluations, fuzzy logic, and the like. Further, system 200 illustrates one embodiment of the disclosure; other embodiments are contemplated.

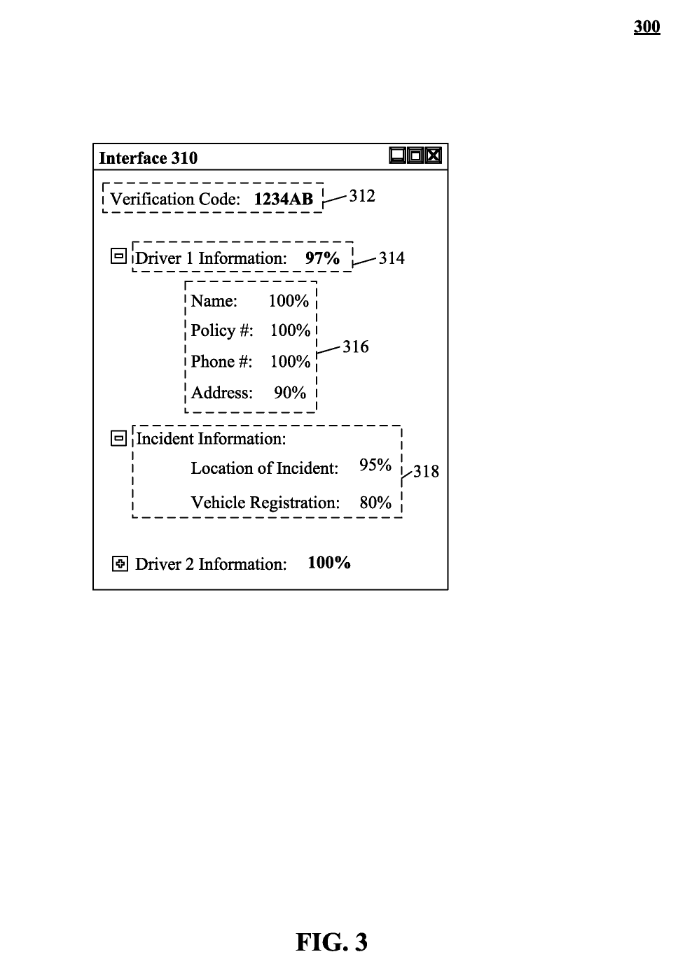

FIG. 3 is a schematic diagram illustrating an exemplary verification report 300 for third party verification of insurable incident claim submission in accordance with an embodiment of the inventive arrangements disclosed herein. In report 300, an interface 310 can be utilized to present verified data associated with insurance claim of an insurable incident. It should be appreciated that verification values presented within report 300 are for illustrative purposes only and can include, but is not limited to, letter grade values, graphical icons, and the like. In one instance, interface 310 can be an optional component of report 300. In the instance, report 300 can be presented in a hard-copy format.

Report 300 can be selectively configured to presentation of verified data. Report 300 can include, but is not limited to, verification code 312, driver information 314-316, incident information 318, and the like. For example, report 300 can be generated with verification information while lacking personally identifiable information. In one instance, report 300 can include non-personally identifiable information (e.g., geographic location).

Verification code 312 can be utilized to identify an insurance claim to which incident data is associated. In one instance, verification code 312 can be presented as a barcode enabling automated archival and/or access. In another instance, verification code 312 can be presented as a hyperlink coupling an associated insurance claim to permit rapid access to claim information.

In section 314, a cumulative verification value can be presented, indicating a total verification assessment of operator (e.g., driver) information. Verification value can be computed utilizing one or more scoring mechanisms. In one instance, verification value can be an average, a weighted average, and the like. In another instance, verification value within section 314 can be generated utilizing a proprietary algorithm.

In section 316, an itemized presentation of operator information can be presented with associated verification values. In section 316, each portion of operator information can be presented with an appropriate label and the computed verification value. Section 316 can present an arbitrary quantity of operator information based on report 300 configuration. That is, section 316 can be tailored to selectively present validated information which can be relevant to external entities (e.g., medical agencies).

Drawings presented herein are for illustrative purposes only and should not be construed to limit the invention in any regard. Verification values presented within section 314-318 can appear in one or more user customizable configurations. In one instance, verification values can be presented as a graphical slider (e.g., slider widget). Interface 310 can include, but is not limited to checkboxes, radio dialogs, and the like.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for verifying insurance claim submissions comprising:
receiving incident data for an insurance claim associated with an incident, wherein the incident data is associated with an incident application executing within a computing device, wherein the incident is an insurable event associated with an insurance policy of an insurance carrier;
simultaneously conveying the incident data to an independent third party entity and to the insurance carrier, wherein the third party entity automatically verifying the incident data and generating a verification report, wherein the verification report is associated with the insurance claim; and
communicating the verification report to the insurance carrier, wherein the verification report is utilized to determine the validity of the insurance claim.

2. The method of claim 1, further comprising:
transmitting the verification report to an external organization, wherein the at least one external organization is at least one of a law enforcement agency, a medical agency, and a legal agency.

3. The method of claim 1, further comprising:
delivering a receipt of submission to a computing device responsive to the simultaneous conveying.

4. The method of claim 1, further comprising:
exchanging the incident data between a plurality of computing devices, wherein the exchange is digitally encoded.

5. The method of claim 4, wherein the digitally encoded information conforms to at least one of a two-dimensional barcode, a Quick Response (QR) code, and a PDF417 barcode.

6. The method of claim 1, wherein the insurable event is a traffic collision.

7. The method of claim 1, wherein the incident data is at least one of a personally identifiable information, vehicle registration information, and insurance information.

8. A system for verifying insurance claim submission comprising:
a verification engine configured to authenticate a plurality of incident data associated with an incident, wherein the incident is an insurable event associated with an insurance carrier, wherein the incident data is associated with an insurance claim;
a communication handler capable of receiving the incident data, wherein the handler marshalls the incident data into a standardized digital format;
a verification datastore able to persist verified data, wherein the verified data is incident data which is authenticated, wherein the verified data is associated with a claim identifier of the insurance claim; and
a verification report able to identify a plurality of accurate incident data, wherein the verification report comprises of at least one of a verification code, claim identifier, and a verification value.

9. The system of claim 8, further comprising:
an incident application executing within a computing device able to receive incident data associated with the incident.

10. The system of claim 8, wherein the standardized digital format conforms to an Extensible Markup Language (XML) format.

11. The system of claim 8, wherein the communication handler conveys the verification report to at least one of an insurance carrier and an external organization, wherein the external organization is at least one of a law enforcement agency, a medical agency, and a legal agency.

12. The system of claim 8, wherein the communication handler communicates a transaction receipt of the insurance claim submission.

13. The system of claim 8, wherein the verification report lacks personally identifiable information associated with the incident.

14. The system of claim 8, wherein the verification report comprises of at least one of a personally identifiable information, vehicle registration information, and insurance information.

15. An apparatus including an interface for verifying insurance claim submission comprising:
a tangible memory storing at least one computer program product;
a processor operable to execute the computer program product to cause the interface window to be displayed by the display hardware; and
the computer program product when run by the processor being operable to receive incident data for an insurance claim associated with an incident, wherein the incident data is associated with an incident application executing within a computing device, wherein the incident is an insurable event associated with an insurance carrier
the computer program product when run by the processor being operable to simultaneously convey the incident data to an independent third party entity and to the insurance carrier, wherein the third party entity automatically verifying the incident data and generating a verification report, wherein the verification report is associated with the insurance claim; and
the computer program product when run by the processor being operable to communicate the verification report to the insurance carrier, wherein the verification report is utilized to determine the validity of the insurance claim.

16. The apparatus of claim 15, wherein the verification report is transmitted to an external organization, wherein the at least one external organization is at least one of a law enforcement agency, a medical agency, and a legal agency.

17. The apparatus of claim 15, wherein a receipt of submission is delivered to a computing device responsive to the simultaneous conveying.

18. The apparatus of claim 15, wherein the incident data is exchanged between a plurality of computing devices, wherein the exchange is digitally encoded.

19. The method of claim 15, wherein the digitally encoded information conforms to at least one of a two-dimensional barcode, a Quick Response (QR) code, and a PDF417 barcode.

20. The method of claim 15, wherein the insurable event is a traffic collision.
